(19) United States
(12) Patent Application Publication
(10) Pub. No.: US 2025/0102830 A1
(43) Pub. Date: Mar. 27, 2025

(54) CONTACT LENS COMPRISING AN OPTICAL ZONE

(71) Applicant: Ohio State Innovation Foundation, Columbus, OH (US)

(72) Inventors: Melissa BAILEY, Columbus, OH (US); Heidi L. HALL, Columbus, OH (US)

(21) Appl. No.: 18/834,079

(22) PCT Filed: Jan. 27, 2023
(86) PCT No.: PCT/US2023/061450

§ 371 Date: Jul. 29, 2024

Related U.S. Application Data
(60) Provisional application No. 63/304,328, filed on Jan. 28, 2022.

(51) Int. Cl. G02C 7/04

(52) U.S. Cl. CPC G02C 7/043; G02C 7/048

(57) ABSTRACT

Disclosed herein is a contact lens comprising a an optic zone formed on a lens portion of the contact lens, the optic zone having a single power or multiple powers, and one or more transition zones between the one or more of the powers. The contact lens can also include a rear surface configured to center the contact lens on the cornea of the patient. In some instances, the contact lens may include a lenticular located in the superior portion of the contact lens, wherein the contact lens attaches to an upper eyelid of a wearer by the lenticular interacting with an upper tarsal plate of the upper eyelid of a wearer, said interaction causing the contact lens to translate upwards in downgaze.

### CROSS-REFERENCE TO RELATED APPLICATION

This application claims priority to and benefit of U.S. Provisional patent application Ser. No. 63/304,328 filed Jan. 28, 2022, which is fully incorporated by reference and made a part hereof.

### BACKGROUND

The current state-of-the art in rotational stabilization includes back surface toricity (effective for rigid gas-permeable contact lenses), base-down and peri-ballast prism, or Dynamic Stabilization which is a modification of base-down prism. However, there are patients for whom one or none of the existing designs are sufficient to provide rotational stabilization for a contact lens and clear vision at multiple distance ranges.

Furthermore, in addition power contact lens, the distance to near transition is incredibly small—5 mm maximum total usable zone size. Thus, distance and near images may appear faintly in the opposite zone. Prismatic effects of the convention higher plus- and minus-shaped lenses will cause image jump and displacement.

Therefore, what is needed in the art are contact lenses that provide rotational stability and centration, that translate upwards in a downgaze through the interaction with the upper eyelid, that also include transition zones between different optical powers where prismatic effects are minimized.

### SUMMARY

The present disclosure relates to translating contact lenses that work when the cornea is spherical or toric. For rotational stabilization, the contact lenses disclosed herein have an advantage over base-down prism, peri-ballasting, and Dynamic Stabilization in that generally an interaction between a lenticular (or lenticular aspect) described below and the upper eyelid tarsal plate to stabilize the contact lens and may also use the interaction between the base of the prism and the lower eyelid. Interactions between the lens and one or both eyelids provides better stabilization in the lens design disclosed herein. This same contact lens design also allows for the contact lens to have a translational movement when the patient looks from straight ahead gaze into downgaze. Instead of pushing the base of the prism in the contact lens upwards with the lower eyelid, as much of the prior art attempts to do, this design pulls the contact lens upwards with the superior lenticular aspect. This is because the lenticular aspect allows the contact lens to use a “lid-attached” fit, wherein the lens stays with the upper lid as the patient looks downwards. Such lid-attached contact lenses are further described in U.S. Pat. No. 10,191,302 issued Jan. 29, 2019, U.S. Pat. No. 10,598,957 issued Mar. 24, 2020, U.S. Pat. No. 11,022,816 issued Jun. 1, 2021, and U.S. Pat. No. 11,022,817 issued Jun. 1, 2021, each of which are fully incorporated by reference and made a part hereof.

The present disclosure also relates to contact lenses that include a lenticular and one or more transition zones between optical zones. The optical zones can allow for clear vision at multiple distances. Further, the present disclosure also includes contact lenses that include a steeper-than-normal base curve radius on the back surface, and/or larger edge lift regions on the back surface. Combined with the lenticular described herein, these surfaces enable the lens to center when the user gazes straight ahead, but also move when the user looks into downgaze.

Furthermore, the present disclosure relates to contact lens where minimization of the prismatic effect is accomplished with a customized alignment by power allows for faint image from opposite zone to be overlayed on in-focus image.

The description below sets forth details of one or more embodiments of the present disclosure. Other features, objects, and advantages will be apparent from the description and from the claims.

### BRIEF DESCRIPTION OF THE DRAWINGS

The accompanying figures, which are incorporated in and constitute a part of this specification, illustrate several aspects described below.

FIGS. 1A and 1B are schematic diagrams providing frontal (FIG. 1A) and a profile view (FIG. 1B) of a bifocal contact lens according to lens designs disclosed herein. FIGS. 1A and 1B show a lenticular 101 comprising a minus-carrier lenticular-like curve located on or proximate the superior edge of the contact lens 100.

FIGS. 1C and 1D are schematic diagrams providing frontal (FIG. 1C) and a profile view (FIG. 1D) of an alternate bifocal contact lens according to lens designs disclosed herein. FIGS. 1C and 1D show a lenticular 101 comprising a minus-carrier lenticular-like curve located further toward the center of the contact lens away from the superior edge of the contact lens 100.

FIGS. 2A (front view) and 2B (profile view) are schematic diagrams of a contact lens showing a “push” and “pull” mechanism associated with a superior lenticular and an inferior prism segment.

FIG. 3 is a schematic diagram of a frontal view of a contact lens including transition zones, according to lens designs disclosed herein.

FIG. 4 is an illustration of the rotation of the optical axis for the intermediate and near portions of the optical zone that can be adjusted to reduce ghosting.

FIG. 5 is an illustration of an embodiment of a contact lens having a back surface where the center of the back surface has a slightly steeper-than-normal base curve radius.

FIG. 6 is an illustration of a method of joining optic regions of a contact lens.

### DETAILED DESCRIPTION

The present disclosure now will be described more fully hereinafter with reference to specific exemplary embodiments. Indeed, the present disclosure can be embodied in many different forms and should not be construed as limited to the embodiments set forth herein.

Disclosed herein is a contact lens having an optical zone. In some embodiments, the contact lens further comprises a lenticular over an upper (superior) portion of the lens. For example, the lenticular may comprise a rounded, minus-carrier, lenticular-like curve over a central, upper portion of the lens, though other lenticular shapes, designs and locations are contemplated. As used herein, “lenticular” or “lenticular aspect” refers to one or more elevated sections in a superior portion of the contact lens located so that at least one of the elevated sections interacts with the upper tarsal plate in a manner that it attaches the contact lens to the inside of the upper eyelid. “Elevated,” as used herein, means that the lenticular extends 0.01mm to 1.0 mm or more above the normal surface of the outwardly-facing side of the contact lens away from the eye. In some instances, the optical zone comprises an addition power zone. “Addition power,” as used herein, refers to the contact lens having an optical zone that is bifocal, trifocal, progressive addition, etc.

Some embodiments of a contact lens disclosed herein comprises a superiorly-located lenticular design that creates: (1) rotational stability of the contact lens in all gazes, (2) upwards translation, or movement, of the contact lens when the eye is in downward gaze, and (3) a general, centered placement of the contact lens over the cornea and the pupil as needed as the person's gaze changes. By “upwards translation of the contact lens when the eye is in downward gaze” means that the contact lens is held in an upwards position when the patient looks down. Some of the embodiments disclosed and described herein include one or more lenticulars located in a superior portion of the contact lens where the lenticular has any shape that would allow any contact lens (soft, rigid gas permeable, hybrid, etc.) to attach itself to the inside of the upper eyelid.

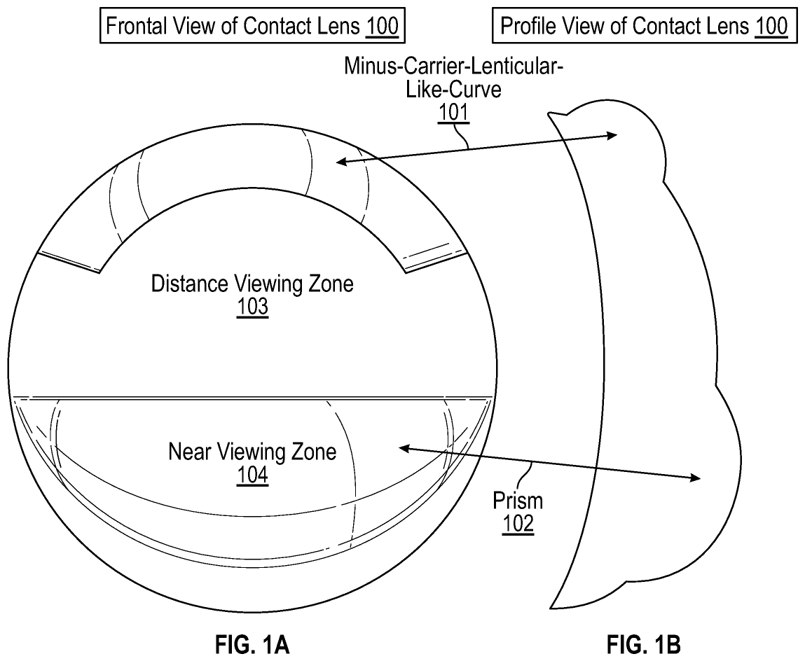

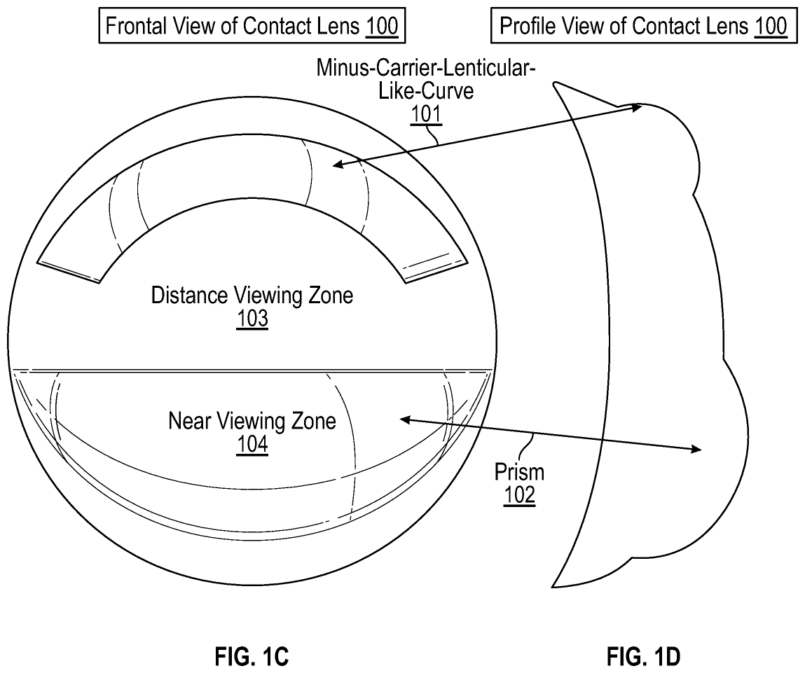

Referring to FIGS. 1A and 1B, a schematic diagram of frontal (FIG. 1A) and profile view (FIG. 1B) of an exemplary bifocal contact lens 100 according to lens designs disclosed herein is illustrated. The lens is a bifocal in that is has a distance viewing zone 103 and a near viewing zone 104. One of the features of the contact lens shown in FIGS. 1A and 1B is the placement of a lenticular 101 over the upper, central portion of the contact lens. As described herein, the upper portion of the contact lens 100 is referred to as the superior portion and the lower portion of the contact lens 100 is referred to as the inferior portion. Generally, the lenticular 101 is located completely in the superior portion of the contact lens 100 above a horizontal midline that passes through the center of the contact lens 100; however, the ends of one or more of the lenticulars may extend into the inferior portion of the contact lens that lies below the horizontal midline. In the embodiment shown in FIGS. 1A and 1B, the lenticular 101 comprises a rounded, minus-carrier-lenticular-like-curve that extends in an arc around a portion of the upper edge of the contact lens 100, though other shapes, sizes and designs of lenticulars 101 are contemplated within the scope of embodiments of this invention and disclosed herein. Another feature of the design shown in FIGS. 1A and 1B is the possible use of prism 102 or a ballast in the lower portion of the contact lens 100. The combined features of the contact lens 100 disclosed herein provide rotational stabilization, translation, and/or centration. The contact lens disclosed herein can be a rigid gas permeable or soft contact lens design, or a hybrid design, such that the contact lens has a rigid center with soft surround. The lens can be made of a material that can sense light activity or molecules in the ocular environment and that contains elements that modulate light or the surrounding ocular environment, i.e., liquid crystal displays, filters, photochromatic materials, compartments containing other materials, or sensors. Though shown in FIGS. 1A and 1B as bifocal lens, it is to be appreciated that the contact lens 100 described herein can be of any vision including single-vision, bifocal, progressive addition, toric, etc.

In FIGS. 1A, 1B, 1C and 1D, the lenticular 101 can be seen at the top of the contact lens 100. The lenticular 101 (in this example a minus-carrier-lenticular-like-curve) can be placed at the upper edge of the contact lens 100, as seen in FIG. 1B, or can be located some distance from the edge of the contact 100, as can be seen in FIG. 1D. For example, the lenticular 101 can be located in the central, upper portion of the contact lens 100. The lenticular 101 can be 0.1, 0.2, 0.3, 0.4, 0.5, 0.6, 0.7, 0.8, 0.9, 1.0, 1.5, 2.0, 2.5, 3.0, 3.5, 4.0, 4.5, or 5.0 millimeters, or more, less, or any amount in-between, away from the outer edge of the contact lens 100. A prism 102 or ballast can be located in the lower half of the contact lens 100. The use of prisms is discussed in more detail herein.

The current state-of-the-art in translating contact lenses is a rigid gas permeable contact lens. There are currently no successful soft contact lenses that achieve translating vision. All of the prior art in translating soft contact lenses moves in the opposite direction of this design, i.e., all other designs attempt to thin the upper portion of the contact lens as much as possible, rather than making it thicker and attached to the upper eyelid. The contact lens disclosed herein provides a translating contact lens, including a soft contact lens, which is more comfortable and requires less adaptation time than a rigid gas permeable lens. Generally speaking, patients are more willing and able to wear a soft contact lens than a rigid gas permeable contact lens, and a soft contact lens requires less expertise to fit. The current state-of-the-art in bifocal, progressive addition, etc. soft contact lenses is simultaneous vision. In these lenses, both the rays focusing the distance vision and the rays focusing the near vision are within the pupil at the same time. Thus, the patient must be able to ignore the rays that are not in focus. This leads to some degradation of vision. The translating soft contact lens disclosed herein allow only light from one distance to be in focus at a time, providing clearer vision at each distance.

The other current state-of-the-art option for fitting presbyopic patients in soft contact lenses is called monovision. In this case, one eye is powered for distance vision (usually the dominant eye) and one eye is powered for near vision (usually the non-dominant eye). Some patients are unable to adapt to this type of lens, again, especially when the patient requires a greater reading add power. The difference between the two eyes becomes too uncomfortable. Also, it is well established that monovision correction in contact lenses or laser vision correction leads to a loss of depth perception. The translating soft contact lens disclosed herein allows for the use of higher reading add powers without degradation of the quality of distance vision. Because both eyes are fully and equally corrected at distance and near in the disclosed design, there is no induced loss of depth perception. The translating soft contact lens disclosed herein can also have an optical segment that provides a gradient of power change between the distance and near segments.

The contact lenses disclosed herein are designed to suit many practical purposes. For example, in both rigid and soft contact lenses, the lens designs disclosed herein provide rotational stabilization in all gazes for toric contact lens designs, contact lenses designed to correct for various types of ocular aberration beyond a spherical correction, for electronically-generated and/or virtual optically displayed images, and/or bifocal, progressive addition, etc. contact lenses. Additionally, the lens designs disclosed herein create upwards translation of a bifocal/progressive addition, etc. contact lens in downward gaze. Furthermore, the lens designs disclosed herein achieve a “lid attached” fit similar to rigid gas permeable contact lens, i.e., keep the contact lens attached under the upper eyelid before, during, and after a blink.

In one embodiment, the upper portion of the contact lens interacts with an upper eyelid of the wearer. The upper portion of the contact lens that interacts with the upper eyelid can comprise 5, 10, 15, 20, 25, 30, 35, 40, 45, 50, 55, 60, 65, 70, or 75% of the area between the upper edge of the contact lens and the geometric center of the contact lens. For example, the area of the upper portion of the contact lens (meaning the “top half” of the contact lens, or the area between the upper edge and geometric center of the contact lens) that interacts with the upper eyelid can comprise 10 to 50% of the upper area of the lens.

Conventionally, a minus carrier lenticular can be used in rigid gas permeable contact lenses in order to create a lid attached fit in a plus-shaped contact lens. In the contact lens design disclosed herein, a lenticular 101 is placed in the central, upper portion of the lens only, rather than over a larger portion of the lens circumference. Some embodiments of the lens designs disclosed herein have a smaller area where a relatively thick edge is present to interact with the upper eyelid margin, and the minimal presence of the lenticular improves comfort over a more traditional minus carrier lenticular that would ordinarily be placed over the entire lens circumference. There is enough surface area and thickness of the lenticular present in the contact lens disclosed herein; however, to interact with the upper tarsal plate to assist with centration and rotational stability. Furthermore, the lenticular 101 is positioned in the superior portion of the contact lens such that interacts with the upper tarsal plate in a manner that it attaches to the upper eyelid. The lenticular 101 does not just interact with the margin of the upper eyelid.

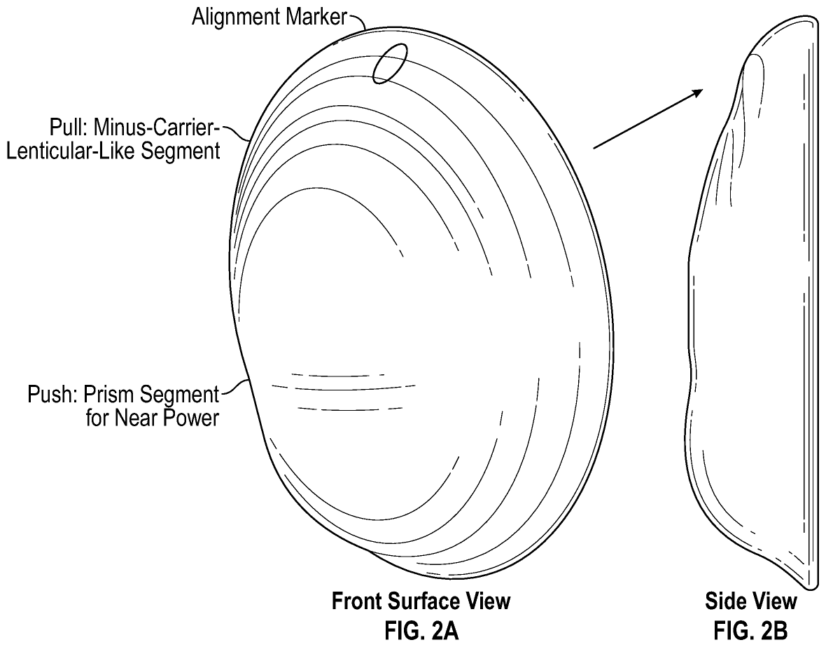

As shown in FIGS. 2A and 2B, and referred to herein as a “push” and a “pull” mechanism, in addition to the upper eyelid interacting with the lenticular, the upper eyelid can also interact with an optional prism in the lower portion of the contact lens according to the lens designs disclosed herein. The edge of the upper eyelid squeezes the thicker, base of the prism of the contact downwards with each blink. The base of the prism also interacts with the lower eyelid with each blink; therefore, the base of the prism is placed above the lower contact lens margin, high enough to remain above the lower eyelid when the eye is open. Just as multiple base curve options are available for fitting different corneal curvatures, multiple heights of the prism base are optionally used to account for differences in aperture size and position of the eyelids. In addition, multiple overall diameters of the contact lens can also be used. In other words, the prism portion can provide a change in power from the central optic zone of the contact lens. The base of the prism may not slide more than 1, 1.5, 2, 2.5, or 3 millimeters (mm) behind the lower eyelid, when in the patient is looking straight ahead and/or downwards when the eye is open and during the blink.

As disclosed above, the contact lens comprises a relatively thick area compared to the remaining portion of the contact lens. This area of thickness can be 1.5, 2, 3, 4, 5, 6, 7, 8, 9, or 10 times thicker than the remaining “non-thick” portion of the contact lens. For example, the relatively thick area can comprise a thickest portion, which is 2 to 10 times thicker than the remaining center portion of the contact lens.

The embodiments of contact lens disclosed herein can be used in the correction of ametropia (myopia, hyperopia, astigmatism, and/or higher order aberrations) in patients with or without presbyopia, i.e., a reading add that moves upwards through translation, in patients with other accommodative disorders, and/or patients with a binocular vision disorder can also be provided in the lens designs disclosed herein. Presbyopia affects approximately 100% of the population who live long enough (approximately >45 years of age) to develop the condition. The embodiments of contact lens disclosed herein can also treat other accommodative disorders, or binocular vision disorder. In some instances, embodiments of the contact lens disclosed herein can be used to display an electronically-generated and/or other virtual optically-displayed image.

Conventional contact lenses provide very limited options in terms of design parameters such as diameter and curvature. The disclosed contact lenses achieve translation in a soft contact lens. Soft contact lenses are typically only feasible to manufacture in two base curve options, and very few are offered in multiple diameters. These multiple options in these two parameters in addition to the ability to vary the prism height, size, amount, or axis are optionally considered in the lens designs disclosed herein. Back or front surface toricity takes advantage of a toric, rather than spherical, corneal shape that occurs in some patients with astigmatism. The lenses disclosed herein still work when the cornea is spherical (not toric). The described lenses also have an advantage over base-down prism, peri-ballasting, and Dynamic Stabilization in that it optionally uses a lenticular aspect described above to use the upper eyelid tarsal plate to stabilize the contact lens in addition to the prismatic interaction of the lower eyelid (in lenses having an inferior prism or ballast). Interactions with both eyelids can provide better stabilization. In implementations described herein, the interaction between the lenticular and the upper tarsal plate of the upper eyelid of a wearer can cause the contact lens to translate upwards in downgaze.

Furthermore, disclosed herein are additional configurations of optical zones that can be formed on contact lenses. With reference to FIGS. 1A and 1C, the optical zones can be formed as part of the viewing zones 103 104. The viewing zones 103 104 can also be described collectively as the “lens portion” of the contact lens. These optical zones can be designed to be vertically small (as measured from the surface of the contact lens) and allow a patient to have discrete vision at distance vision, intermediate vision, and near vision. Further, the optical zones described herein can be configured to avoid unwanted prism and/or other aberrations in each of the zones. The transition between each zone can be small, or very small when compared to conventional contact lenses.

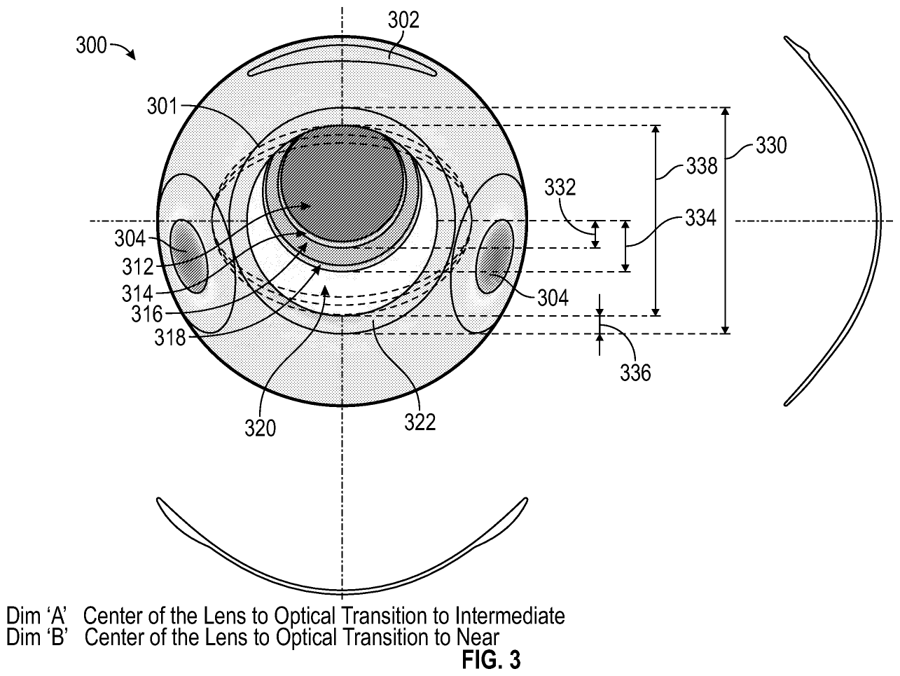

As a non-limiting example, the optical zones described can be used as alternatives to the optical zones shown in FIGS. 1A-1D, 2A and 2B. Additionally, the optical zones described herein can be formed on other contact lenses, including contact lenses that include a superior lenticular aspect, as well as contact lenses that include a minus-carrier lenticular-like curve. A schematic of an embodiment of a contact lens 300 including an optical zone 301 is shown in FIG. 3. FIG. 3 illustrates the front surface of contact lens 300, with shading illustrating different features formed in the lens 300. A lenticular 302 is formed on the top surface of the lens 300. The lenticular 302 can be a superior lenticular aspect, or a minus-carrier lenticular-like curve. Alternatively and/or optionally, one or more ballast zones 304 can be formed on the lens 300. In the center of the lens 300, an optic zone 301 is formed including different powers 312 316 320, and transition zones 314 316 between the different powers 312 316 320. A distance power 312 is formed in the lens 300. An intermediate power 316 is also formed on the lens 300, with a first transition zone 314 between the intermediate power 316 and distance power 312. A near vision power 320 is also formed on the lens 300 with a second transition zone 318 between the near vision zone 320 and the intermediate zone 316. It is also possible to have only two zones, one that is for distance, and one that is for near, without a zone for intermediate.

A challenge with contact lens having optical zones with addition powers is that distance to near transition is incredibly small—5 mm maximum total usable zone size. Thus, distance and near images may appear faintly in the opposite zone (i.e., “ghosting”) due to a small portion of the light bundle transmitting through each zone. Furthermore, prismatic effects of the higher plus- and minus-shaped lenses may cause perceptible image jump and displacement between image and ghost and between images from different zones. Minimization of this prismatic effect is accomplished with a customized alignment by power that allows for faint image from opposite zone to be overlayed on in-focus image.

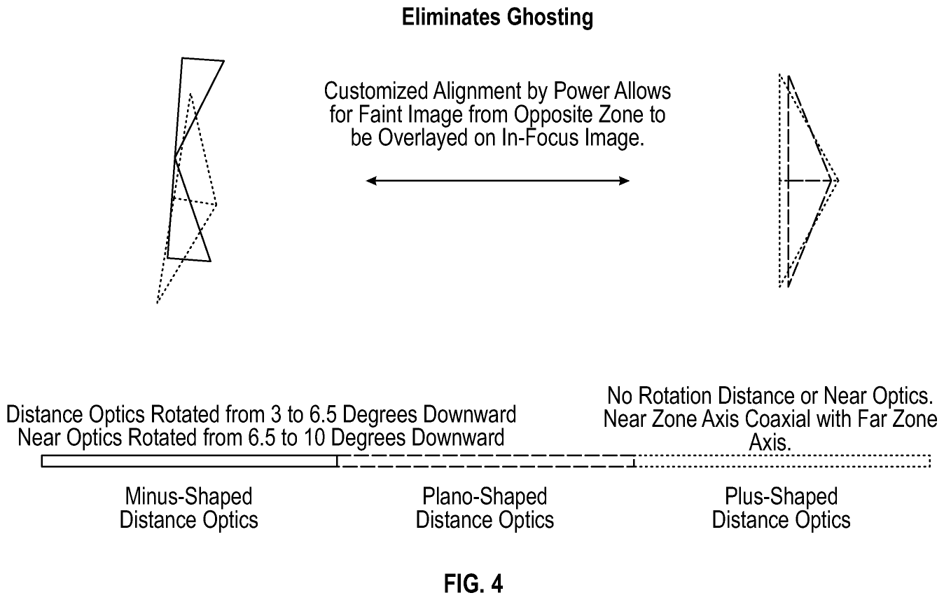

As shown in FIG. 4, the rotation of the optical axis for the intermediate and near portions can also be adjusted to reduce ghosting that can be created by the out-of-focus image, for example having the near image contained partially within the pupil while looking at distance and vice versa. The location and noticeableness of near image appearing as an out-of-focus image within the distance region is dependent upon the power of both the distance and near regions of the optical zone. Separate solutions are needed. The prismatic effects of a plus-shaped (thicker center, thinner edge) optical zone lead to a more-superior and more-noticeable out-of-focus near image within the distance zone. This is mitigated by using an intermediate/near/progressive addition zone that has an optical axis that is parallel to the distance zone's optical axis, rather than rotating that optical axis downwards to align with 2, 3, or 4 mm of upwards translation of the lens and optical axis of the eye when the eye is in downgaze. This allows the out-of-focus distance image to be better aligned with as the in-focus near image, or vice versa, making the out-of-focus image less perceptible to the wearer. In the case of a minus-shaped distance (thicker edge and thinner center) optical zone, a different strategy is used to achieve the same effect. The minus-shaped distance zone axis and the near zone axis are both rotated downwards; the distance zone axis is rotated by a smaller amount) (3-6.5° than the near zone axis) (6.5-10°. For lenses where the distance power is a more-parallel shape (similar center and edge thickness), there is little prismatic effect in the distance optical zone and the rotation of the optical axes of the various zones can take on either configuration with similar results.

Referring again to FIG. 3, different dimensions of lenses and optical zones are contemplated. Additionally, alternative embodiments may include different numbers of transition zones 314 318 and different numbers of vision powers 312 316 320. In the non-limiting example lens shown in FIG. 3, the distance power 312 can have a width or diameter or region within the lens that is 1 mm to 9 mm. The first transition vision zone 314 can have a width from. 1 mm to 3 mm. The intermediate vision power 316 can have a width from 0.5 mm to 3 mm, and the second transition zone 318 can have a width from 0.1 mm to 3 mm. The near vision power 320 can have a width from 0.5 mm to 6 mm. The embodiments described herein can minimize or eliminate astigmatism through the use of the transition zones 314 318 between different vision powers or regions within the optical zone 312 316 320. Further, embodiments of the present disclosure can provide clear vision at any distance or multiple distances.

Additionally, still referring to the non-limiting example lens 300 in FIG. 3, additional example dimensions are provided herein. The front optic zone diameter 330 can be from 5 mm to 11 mm. The distance 332 from the center of the lens to optical transition to intermediate vision can be in the range from 0 mm to 2 mm. Further, the distance 334 from the center of the lens to the optical transition to near vision can be in the range from 0.5 mm to 5 mm. The optic zone 301 can include a blend region 322 between the optic zone 301 and the other parts of the contact lens 300. The FOD-Blend/Blend Width (Front optic zone diameter blend into lens periphery) 336 is also illustrated, and in the non-limiting example of FIG. 3 this can range from 0.1 mm to 4 mm. FIG. 3 also illustrates the size of the FOD-Blend region 338 that can range from 0.1 mm to 4 mm.

Throughout the present disclosure, the “height” of the transition zones 314 318 is measured vertically along the contact lens 300. The height of the transition zones 314 318 and visual powers 312 316 320 illustrated in FIG. 3 is at least 1 mm. However, in different embodiments, the zones or powers 312 314 316 318 320 may have different heights, for example one or more zones or powers 312 314 316 318 320 can be less than 1 mm.

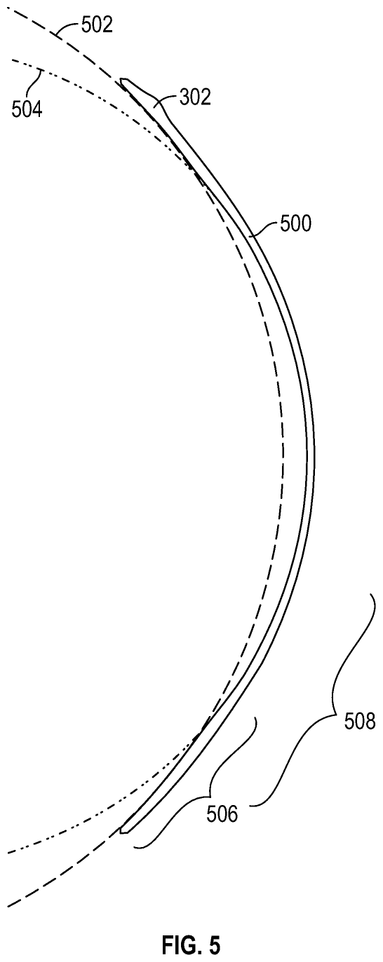

Additionally, still referring to FIG. 3 embodiments of the present disclosure can include contact lenses 300 with different back or “rear” surface shapes (not shown) where the “back” or “rear” surface is the surface of the contact lens that is proximate to the eye of the wearer. If the back surface of the contact lens 300 is too flat or relatively less sagittal depth compared to the wearer's eye, then the contact lens can move and can be off center (as compared to the user's eye). For example, the lens could move into a superior or very superior orientation relative to the cornea. Embodiments of the present disclosure include a back surface where the center of the back surface has a slightly steeper-than-normal soft contact lens base curve radius as shown in FIG. 5. The slightly steeper than normal base curve radius 502 is more similar to the actual central corneal curvature, and allows the contact lens 500 to center on the cornea 504 (which flattens from the center of the cornea to the periphery of the cornea). Further, the periphery 506 of the contact lens can be flattened at the edge lift to make the mid-periphery 508 and periphery 506 of the contact lens flatter than a conventional soft contact lens. The edge lift region can also be made larger, or to take up a wider region on the back surface of the contact lens, than a conventional contact lens. The superior lenticular 302 can allow the lens 500 to stay in the correct position relative to the eye, without moving excessively. Further the combination of the steeper central portion, flatter/wider edge lift, and superior lenticular 302 can allows the lens to center in straight ahead gaze but still move when the user of the contact lens 500 looks into downgaze, as the superiorly-located lenticular will hold the lens upwards as the user looks into downgaze.

Disclosed herein are also methods of making the contact lenses disclosed herein. For example, disclosed is a method of making a contact lens, the method comprising manufacturing a contact lens comprising forming a rounded, minus-carrier, lenticular-like curve over a central, upper portion of the lens. The contact lens can further comprise a base down prism in the inferior portion of the lens where the minus-carrier, lenticular-like curve. In one example, the base down prism is added to the lens in a second step of a manufacturing process. In some implementations, the contact lens is fabricated using a lathe (i.e. by the process of “lathing”) or a mold. Optionally, the mold for forming the contact lens can be fabricated using a lathe. In some implementations, the contact lens is fabricated partially or completely by using a die. In some implementations, the design parameters of the contact lens can be determined by, or based on, the characteristics of the lathe. These lathe characteristics can include the rate at which the lathe can accelerate or decelerate, or the size of the lathe. When the lathe is used to fabricate a mold, the characteristics can impact the characteristics of a mold for forming the contact lens, which can therefore impact the characteristics of the contact lens formed using a mold.

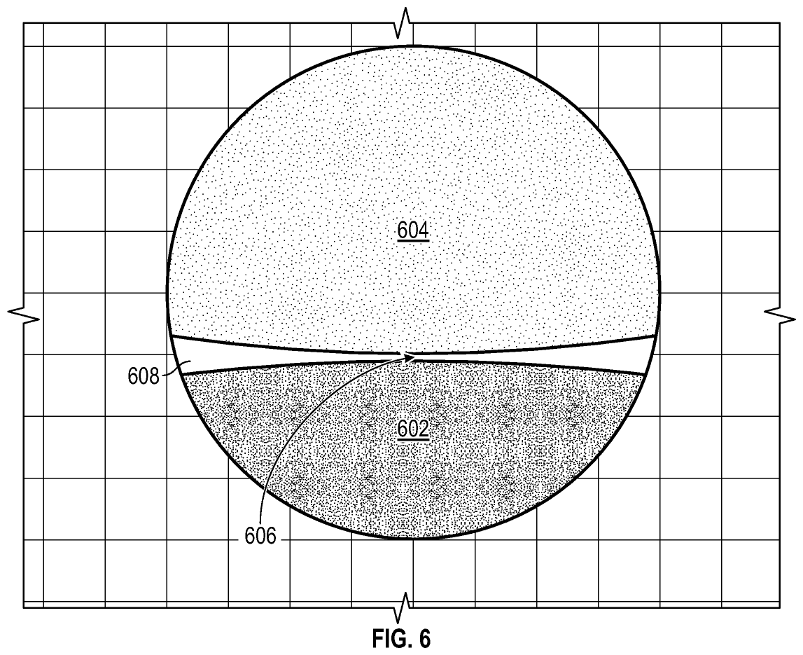

For example, as shown in FIG. 6 is a method of joining optic regions of a contact lens. In FIG. 6, the inferior optic 602 is positioned along the distance zone optical axis in such a way as to intersect the two zones 602, 604 at the position 606 marked in FIG. 6. The difference in curvature between the two zones 602, 604 leaves a gap 608, which increases as the distance increases from the center of the contact lens. Forming to contact lens requires blending these two zones 602, 604 together and filling in the gap 608.

Also disclosed is a method of treating an individual in need of vision correction, the method comprising dispensing the contact lens disclosed herein to the individual, thereby treating the individual in need of vision correction. In one example, the individual has been diagnosed with ametropia. In another example, the individual has been diagnosed with presbyopia, another accommodative disorder, and/or a binocular vision disorder.

As used in the specification, and in the appended claims, the singular forms “a,” “an,” “the,” include plural referents unless the context clearly dictates otherwise.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

1. A contact lens comprising:
a superior portion of the contact lens;
an inferior portion of the contact lens;
a lens portion;
a lenticular located in the superior portion of the contact lens, wherein the contact lens attaches to an upper eyelid of a wearer by the lenticular interacting with an upper tarsal plate of the upper eyelid of a wearer, said interaction causing the contact lens to translate upwards in downgaze; and
an optic zone formed on the lens portion of the contact lens, the optic zone having multiple powers, and one or more transition zones between one or more of the powers.

2. The contact lens of claim 1, wherein the multiple powers of the optic zone comprise a first optical power, a second optical power, and an optional third optical power.

3. The contact lens of claim 2, wherein the first optical power comprises a distance optical region, the second optical power comprises a near optical region, and the optional third optical power comprises an intermediate or progressive addition optical region.

4. The contact lens of claim 3, wherein the distance optical region comprises a plus-shaped (thicker center, thinner edge) optical zone and the near optical region, and/or the intermediate and/or progressive addition optical region comprises an optical axis that is parallel to an optical axis of the distance optical region such that an out-of-focus image is in a same location as an in-focus distance image, or vice versa, making the out-of-focus image less perceptible to a wearer.

5. The contact lens of claim 3, wherein the distance optical region comprises a minus-shaped distance (thicker edge and thinner center) optical zone and the near optical region, and/or the intermediate and/or progressive addition optical region comprises an optical axis that is rotated downward and an optical axis of the distance optical region is also rotated downward.

6. The contact lens of claim 5, wherein the optical axis of the near optical region, and/or the intermediate and/or progressive addition optical region is rotated downward by a larger amount than the optical axis of the distance optical region.

7. The contact lens of claim 6, wherein the optical axis of the near optical region, and/or the intermediate and/or progressive addition optical region is rotated downward by 6.5°-10°, and the optical axis of the distance optical region is rotated downward by 3°-6.5°.

8. The contact lens of claim 2, wherein the transition zone further comprises a first transition zone and an optional second transition zone, wherein the first transition zone is formed between the first optical power and the second optical power and the optional second transition zone is formed between the second optical power and the optional third optical power.

9. The contact lens of claim 8, wherein the first transition zone is between 0.1 mm and 3 mm.

10. The contact lens of claim 8 wherein the optional second transition zone is between 0.1 mm and 3 mm.

11. The contact lens of claims 8, wherein the first transition zone and the optional second transition zone have different widths.

12. The contact lens of claims 1 wherein the multiple powers comprise a distance vision power, an optional intermediate vision power, and a near vision power.

13. The contact lens of claim 12, wherein the distance vision power is between 1 mm and 9 mm in wide.

14. The contact lens of claim 12 wherein the optional intermediate vision power is between 0.5 mm to 3 mm wide.

15. The contact lens of claim 12, wherein the near vision power is between 0.5 mm and 6 mm wide.

16. The contact lens of claim 1, further comprising a front surface and a rear surface opposite the front surface, said rear surface proximate an eye of the wearer, wherein the rear surface comprises a base curve radius region, and a peripheral region, wherein the base curve radius region and the peripheral region are configured to center the contact lens when the contact lens is placed on a cornea of a patient, but still allow for controlled movements such as upwards translation.

17. The contact lens of claim 16, wherein the base curve region has a steeper-than-normal slope and the peripheral region is wider than normal.

18. The contact lens of claim 2, wherein the distance between a center point of the contact lens and the first optical power is between 0 to 2 mm.

19. The contact lens of claim 2, wherein the distance between a center point of the contact lens and the second optical power is between 0.5 mm and 5 mm.

20. The contact lens of claim 1, wherein the optical zone is between 5 mm and 11 mm in diameter.

21. The contact lens of claim 1, wherein the optical zone further comprises a blend zone located at an outside edge of the optical zone.

22. The contact lens of claim 21, wherein the blend zone is between 0.1 mm and 4 mm wide.

23-41. (canceled)

42. A method of making a contact lens comprising:
forming a lenticular located in a superior portion of the contact lens, wherein the lenticular is formed to attach to an upper eyelid of a wearer by the lenticular interacting with an upper tarsal plate of the upper eyelid of a wearer, said interaction causing the contact lens to translate upwards in downgaze; and
forming an optic zone on a lens portion of the contact lens, the optic zone having multiple powers, and a transition zone between one or more of the powers.

43. The method of claim 42, wherein the contact lens is at least partially formed using lathing.

44. The method of claim 42, wherein the contact lens is at least partially formed using a die.

45. (canceled)

46. (canceled)

47. A contact lens comprising:
a superior portion of the contact lens;
an inferior portion of the contact lens;
a lens portion; and
an optic zone formed on the lens portion of the contact lens, the optic zone having multiple powers, and a transition zone between one or more of the powers,
wherein the multiple powers of the optic zone comprise a first optical power, a second optical power, and an optional third optical power,
wherein the first optical power comprises a distance optical region, the second optical power comprises a near optical region, and the optional third optical power comprises an intermediate or progressive addition optical region, and
wherein the distance optical region comprises a minus-shaped distance (thicker edge and thinner center) optical zone and the near optical region, and/or the intermediate and/or progressive addition optical region comprises an optical axis that is rotated downward and an optical axis of the distance optical region is also rotated downward.

48. The contact lens of claim 47, wherein the optical axis of the near optical region, and/or the intermediate and/or progressive addition optical region is rotated downward by a larger amount than the optical axis of the distance optical region.

49. The contact lens of claim 48, wherein the optical axis of the near optical region, and/or the intermediate and/or progressive addition optical region is rotated downward by 6.5°-10°, and the optical axis of the distance optical region is rotated downward by 3°-6.5°.
